(19) United States
(12) Patent Application Publication
(10) Pub. No.: US 2025/0255346 A1
(43) Pub. Date: Aug. 14, 2025

(54) AEROSOL GENERATION DEVICE AND MICROWAVE HEATING ASSEMBLY THEREOF

(71) Applicant: SMOORE INTERNATIONAL HOLDINGS LIMITED, George Town (KY)

(72) Inventors: Yonghai LAN, Shenzhen (CN); Feng LIANG, Shenzhen (CN); Jing DU, Shenzhen (CN); Yang DENG, Shenzhen (CN); Dongjian LI, Shenzhen (CN)

(21) Appl. No.: 19/195,099

(22) Filed: Apr. 30, 2025

Related U.S. Application Data
(63) Continuation of application No. PCT/CN2022/129371, filed on Nov. 2, 2022.

(51) Int. Cl. A24F 40/46; H05B 6/66; H05B 6/80

(52) U.S. Cl. CPC A24F 40/46; H05B 6/66; H05B 6/802

(57) ABSTRACT

A microwave heating assembly for an aerosol generation device includes: an outer conductor unit having a tubular shape and having an open end and a closed end; and an inner conductor unit arranged in the outer conductor unit, and including: a first fixed end connected to the closed end; and a first free end extending toward the open end, a groove recessed toward the closed end being formed on a surface of the first free end toward the open end, the groove being used to adjust an energy field in the outer conductor unit.

### CROSS-REFERENCE TO PRIOR APPLICATION

This application is a continuation of International Patent Application No. PCT/CN2022/129371, filed on Nov. 2, 2022. The entire disclosure is hereby incorporated by reference herein.

### FIELD

The present invention relates to the field of electronic atomization, and in particular, to an aerosol generation device and a microwave heating assembly thereof.

### BACKGROUND

An aerosol generation device heats and atomizes an aerosol generation product through microwave heating. The aerosol generation device generally includes a microwave heating assembly. The microwave heating assembly forms a microwave interaction region, to transfer microwave energy to the aerosol generation product. In this process, a microwave energy distribution field determines an effect of the microwave heating.

In the related art, the microwave heating assembly is inserted and arranged in the aerosol generation product by using a probe structure, to heat the aerosol generation product. However, during heating, because microwave energy heats the aerosol generation product based on inherent distribution, energy utilization efficiency is not high, or the energy is excessively dispersed, resulting in a possibility that an amount of vapor generated by the aerosol generation product is small or an aerosol generation speed is slow.

### SUMMARY

In an embodiment, the present invention provides a microwave heating assembly for an aerosol generation device, comprising: an outer conductor unit having a tubular shape and comprising an open end and a closed end; and an inner conductor unit arranged in the outer conductor unit, and comprising: a first fixed end connected to the closed end; and a first free end extending toward the open end, a groove recessed toward the closed end being formed on a surface of the first free end toward the open end, the groove being configured to adjust an energy field in the outer conductor unit.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic diagram of an external structure of a microwave heating assembly according to an embodiment of the present invention;

FIG. 2 is a longitudinal structural cross-sectional view of the microwave heating assembly shown in FIG. 1;

FIG. 3 is a longitudinal structural cross-sectional view of the microwave heating assembly shown in FIG. 1 in a disassembled state;

FIG. 4 is a schematic diagram of a structure of a probe element cooperating with an inner conductor unit according to an embodiment of the present invention;

FIG. 5 is an energy distribution diagram obtained by testing a microwave heating assembly according to the present invention; and

FIG. 6 is a schematic diagram that is as a comparison experiment and that is of an energy distribution diagram obtained through testing when a groove is removed according to a structure of a microwave heating assembly of the present invention.

### DETAILED DESCRIPTION

In an embodiment, the present invention provides an improved aerosol generation device and a microwave heating assembly thereof.

In an embodiment, the present invention provides a microwave heating assembly, used in an aerosol generation device, and the microwave heating assembly includes:
an outer conductor unit, being in a tubular shape, and including an open end and a closed end; and
an inner conductor unit, arranged in the outer conductor unit, and including:
a first fixed end, connected to the closed end; and
a first free end, extending toward the open end, a groove recessed toward the closed end being formed on the surface of the first free end toward the open end, and the groove being configured to adjust an energy field in the outer conductor unit.

In some embodiments, the groove is in a cylindrical shape.

In some embodiments, the depth of the groove ranges from 1 mm to 5 mm.

In some embodiments, the inner conductor unit includes:
a conductor column, including a second fixed end and a second free end opposite to the second fixed end, the second fixed end being fixed to the closed end; and
a conductor disk, combined on the second free end, the groove being formed on the surface of the conductor disk that faces away from the second fixed end.

In some embodiments, the conductor disk is integrally formed with the conductor column, or the conductor disk is in ohmic contact with the conductor column.

In some embodiments, the conductor column is in a cylindrical shape, the conductor disk is in a disk shape, and the diameter of the conductor disk is greater than the diameter of the conductor column and less than the inner diameter of the outer conductor unit.

In some embodiments, the groove, the conductor disk, the conductor column, and the outer conductor unit are coaxial.

In some embodiments, the conductor disk is made of a metal material, or the surface of the conductor disk is covered with a conductive coating.

In some embodiments, the metal material includes aluminum alloy or copper.

In some embodiments, the conductive coating includes a silver coating or a gold coating.

In some embodiments, the microwave heating assembly further includes a probe element arranged in the outer conductor unit; and
the probe element is in a longitudinal shape, one end of the probe element passes through the conductor disk and is embedded on the conductor column, and is in ohmic contact with the conductor column, and the other end of the probe element extends toward the open end.

In some embodiments, the microwave heating assembly further includes an accommodating base mounted at the open end, the accommodating base includes an accommodating portion configured to accommodate an aerosol generation product, the accommodating portion is arranged in the outer conductor unit, and one end of the accommodating portion that is adjacent to the conductor disk extends into and is arranged in the groove.

In some embodiments, the spacing is provided between the outer wall surface of the accommodating portion and the inner wall surface of the groove.

In some embodiments, the microwave heating assembly further includes a microwave feeding unit, and the microwave feeding unit includes:
an outer conductor, mounted on the outer conductor unit, and being in ohmic contact with the outer conductor unit;
an inner conductor, arranged in the outer conductor, and being in ohmic contact with the inner side of the outer conductor unit or the inner conductor unit; and
a medium layer, located between the outer conductor and the inner conductor.

In some embodiments, the outer periphery side wall of the outer conductor unit is provided with a feeding hole that communicates the interior of the outer conductor unit with the outside;
the outer conductor is embedded in the feeding hole, and is in ohmic contact with the inner wall surface of the feeding hole; and
the inner conductor passes through the feeding hole, and extends into the outer conductor unit.

The present invention further provides an aerosol generation device. The aerosol generation device includes a microwave generation device, and further includes the foregoing microwave heating assembly. The microwave heating assembly is connected to the microwave generation device.

### Beneficial Effects

Implementation of the present invention has the following beneficial effects: In the present invention, the groove is provided at a corresponding position of the first free end of the inner conductor unit, to adjust energy field distribution inside the outer conductor unit, so that microwave energy is concentrated, and an amount of vapor generated is increased.

In the drawings: microwave heating assembly 100; outer conductor unit 11; inner conductor unit 12; accommodating base 13; probe element 14; microwave feeding device 2; closed end 111; open end 112; conductor side wall 113; conductor end wall 114; feeding hole 115; mounting hole 116; conductor column 121; insertion hole 122; conductor disk 123; screw rod 124; groove 1231; accommodating portion 131; fixed portion 132; positioning rib 133; supporting rib 134; accommodating cavity 1311; through hole 1321; outer conductor 21; inner conductor 22; medium layer 23; connection end 221; and feeding end 222.

To provide a clearer understanding of technical features, objectives, and effects of the present invention, specific implementations of the present invention are described in detail with reference to the accompanying drawings. In the following descriptions, it should be understood that, orientation or position relationships indicated by the terms such as “front”, “rear”, “upper”, “lower”, “left”, “right”, “longitudinal”, “transverse”, “vertical”, “horizontal”, “top”, “bottom”, “inner”, “outer”, “head”, and “tail” are based on orientation or position relationships shown in the accompanying drawings and structures and operations in specific orientations, and are used only for ease of description of the technical solutions, rather than indicating that the mentioned device or element needs to have a specific orientation. Therefore, such terms should not be construed as a limitation to the present invention.

It should be further noted that, unless otherwise clearly specified and limited, terms such as “mounted”, “connected”, “connection”, “fixed”, and “arranged” should be understood in a generalized manner, for example, may be understood as a fixed connection, a detachable connection, or integration; or may be understood as a mechanical connection or an electrical connection; or may be understood as a direct connection, an indirect connection via a medium, an internal communication of two elements, or a mutual relationship between two elements. When an element is referred to as being “upper” or “lower” another element, the element can be “directly” or “indirectly” located above the another element, or one or more intervening elements may also exist. The terms “first”, “second”, “third”, and the like are merely for ease of describing the technical solutions, and should not be understood as indicating or implying relative importance or implicitly specifying the quantity of the indicated technical features. Therefore, a feature limited to “first”, “second”, “third”, and the like may explicitly or implicitly include one or more such features. A person of skilled in the art may understand the specific meanings of the foregoing terms in the present invention based on specific situations.

In the following descriptions, for the purpose of illustration rather than limitation, specific details such as the specific system structure and technology are provided, to thoroughly understand the embodiments of the present invention. However, it should be clear to a person skilled in the art that the present invention may also be implemented in other embodiments without these specific details. In other cases, detailed descriptions of well-known systems, devices, circuits, and methods are omitted, so as not to obscure the descriptions of the present invention with unnecessary details.

According to the present invention, an aerosol generation device is provided. The aerosol generation device heats an aerosol generation product through microwaves, to form an aerosol for a user to inhale. In some embodiments, the aerosol generation product is a solid-state aerosol generation product such as a processed plant leaf product. It may be understood that, in some other embodiments, the aerosol generation product may alternatively be a liquid aerosol generation product.

The aerosol generation device includes a microwave generation device and a microwave heating assembly 100. The microwave generation device can generate the microwaves. The microwave heating assembly 100 is connected to the microwave generation device to access the microwave formed by the microwave generation device, and the microwave heating assembly 100 forms a microwave field inside the cavity of the microwave heating assembly 100. The microwave field is used for the aerosol generation substrate, to implement microwave heating on the aerosol generation substrate.

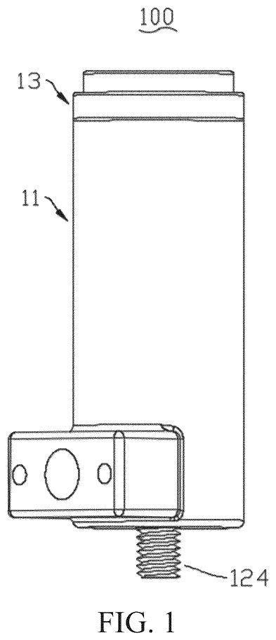

As shown in FIG. 1, in some embodiments, the overall shape of the microwave heating assembly 100 is substantially in a cylindrical shape. Certainly, the microwave heating assembly 100 is not limited to being in a cylindrical shape, and may alternatively be in another shape such as a square columnar shape or an elliptical columnar shape.

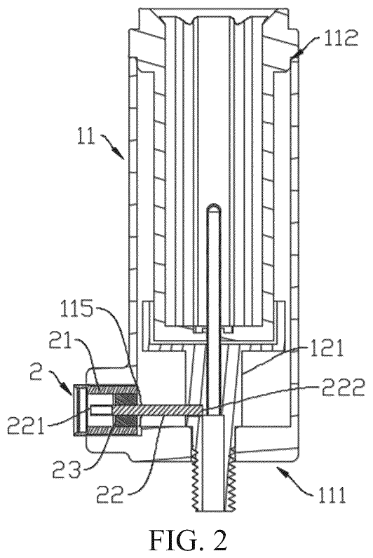

As shown in FIG. 2, the microwave heating assembly 100 includes an outer conductor unit 11, an inner conductor unit 12, a probe element 14, an accommodating base 13, and the microwave feeding device 2.

The outer conductor unit 11 is in a tubular shape (preferably a cylindrical tube), includes a closed end 111 and an open end 112 opposite to the closed end 111, and is defined with a semi-closed cavity. The cavity is in a cylindrical shape.

The inner conductor unit 12 is configured to adjust a resonance frequency and microwave distribution in the cavity, and the inner conductor unit 12 is coaxially arranged in the cavity of the outer conductor unit 11. One end of the inner conductor unit 12 is connected to the closed end 111 of the outer conductor unit 11, and is in ohmic contact with the end wall of the closed end 111, to form a short-circuit end of the microwave heating assembly 100. The other end of the inner conductor unit 12 extends toward the open end 112 of the outer conductor unit 11, and is not in contact with the outer conductor unit 11, to form an open-circuit end of the microwave heating assembly 100.

The accommodating base 13 is configured to receive an aerosol generation substrate, and is fixedly or detachably mounted at the open end 112 of the outer conductor unit 11. When being inserted and arranged in the accommodating base 13, the aerosol generation substrate is located in a region in which the microwave field is mainly formed.

The probe element 14 is configured to adjust microwave field distribution and microwave feeding frequency, and is coaxially arranged in the cavity. The probe element 14 is used as an independent structure, and is coaxially embedded on the inner conductor unit 12 with one end of the probe element 14 extending from the inner conductor unit 12 toward the open end 112 of the outer conductor unit 11. The other end of the probe element 14 extends into the interior of the accommodating base 13, so that one end of the probe element 14 penetrates into the interior of the aerosol generation substrate.

The microwave feeding device 2 is configured to feed the microwaves generated by the microwave generation device into the cavity (a feeding manner includes an electric feeding manner or a magnetic feeding manner, and the electric feeding manner is preferably used). The microwave feeding device 2 is detachably mounted on the outer peripheral wall of the outer conductor unit 11.

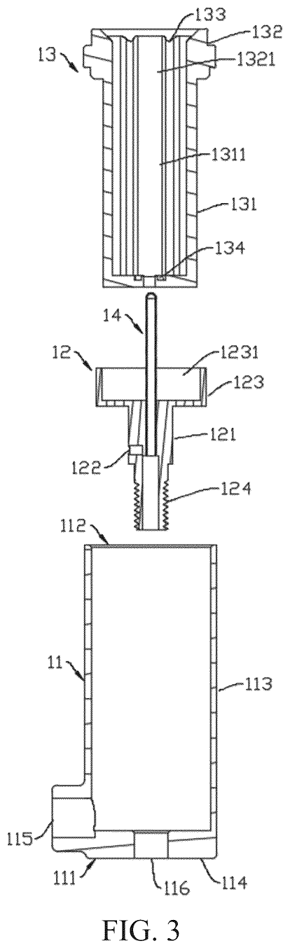

As shown in FIG. 3, in some embodiments, the outer conductor unit 11 includes a conductive conductor side wall 113 and a conductive conductor end wall 114. The conductor side wall 113 is in a tubular shape (preferably a cylindrical tube), and includes two ends that are oppositely arranged. The conductor end wall 114 is closed on the first end of the conductor side wall 113, to form the closed end 111, and the second end of the conductor side wall 113 of the conductor is of an open structure, to form the open end 112, so that the accommodating base 13 can be mounted in the conductor side wall 113. In addition, a radially penetrating feeding hole 115 is provided at a position close to the conductor end wall 114 of the conductor side wall 113. The feeding hole 115 is configured for the microwave feeding device 2 to be inserted and arranged in the interior of the outer conductor unit 11. The aperture of the feeding hole 115 matches the outer diameter of an outer conductor 21 of the microwave feeding device 2. An axially penetrating mounting hole 116 is further provided at a central position of the conductor end wall 114. The mounting hole 116 is configured for the inner conductor unit 12 to be mounted on the mounting hole, to fix one end of the inner conductor unit 12 to the conductor end wall 114.

In some embodiments, the outer conductor unit 11 is integrally made of a conductive metal material, and preferably, the metal material is aluminum alloy or copper. It may be understood that, the outer conductor unit 11 is not limited to being integrally made of a conductive material, and may alternatively be implemented by plating a first conductive coating on the inner wall surface of a non-conductive cylinder. The material of the first conductive coating includes gold, silver, a conductive metal oxide, or the like. Preferably, the first conductive coating is a silver coating or a gold coating.

As shown in FIG. 3, in some embodiments, the inner conductor unit 12 includes a conductor column 121 and a conductor disk 123 arranged above the conductor column 121. Preferably, the axis of the conductor column 121, the axis of the conductor disk 123, and the axis of the outer conductor unit 11 coincide with each other.

The conductor column 121 is in a cylindrical shape. One end (bottom end) of the conductor column 121 that is away from the open end 112 of the outer conductor unit 11 is a fixed end, and is coaxially fixed to the conductor end wall 114 of the outer conductor unit 11. The other end (top end) of the conductor column 121 that is close to the open end 112 is a free end, and extends toward the open end 112 of the outer conductor unit 11. The diameter of the conductor column 121 is less than the inner diameter of the outer conductor unit 11. It may be understood that, the conductor column 121 is not limited to being in a cylindrical shape, and may alternatively be in another shape such as a square columnar shape, an elliptical columnar shape, a staircase columnar shape, or an irregular columnar shape. In addition, an axially extending screw rod 124 is further arranged at the bottom end of the conductor column 121. The screw rod 124 is integrally formed with the conductor column 121, and is configured to be mounted on the mounting hole 116 located on the conductor end wall 114 of the outer conductor unit 11, to fix the conductor column 121 to the conductor end wall 114, so that the conductor column 121 is in reliable ohmic contact with the outer conductor unit 11.

In some embodiments, the conductor column 121 is integrally made of a conductive metal material, and preferably, the metal material is aluminum alloy or copper. It may be understood that, the conductor column 121 is not limited to being integrally made of a conductive material, and may alternatively be implemented by plating a second conductive coating on the external surface of a non-conductor. Preferably, the second conductive coating is plated with a silver coating or a gold coating.

The conductor column 121 is further provided with an insertion hole 122 corresponding to the feeding hole 115. The insertion hole 122 is configured to cooperate with the microwave feeding device 2, to implement microwave conduction. The insertion hole 122 is a blind hole, is in a shape of a straight cylindrical channel, and radially extends toward the interior of the conductor column 121 along the outer peripheral wall of the conductor column 121. Preferably, the aperture of the insertion hole 122 matches the diameter of the inner conductor 22 of the microwave feeding device 2.

The conductor disk 123 is configured to conduct microwaves, further increases inductance and capacitance of the conductor disk 123, and reduces the resonance frequency, thereby facilitating further reduction of the cavity size. The conductor disk 123 is in a disk shape, the diameter of the conductor disk 123 is greater than the diameter of the conductor column 121, and the conductor disk 123 is coaxially arranged on a top end of the conductor column 121. The conductor disk 123 is integrally formed with the conductor column 121, or is in ohmic contact with the conductor column 121.

In some embodiments, the conductor disk 123 is integrally made of a conductive metal material, and preferably, the metal material is aluminum alloy or copper. It may be understood that, the conductor disk 123 is not limited to being integrally made of a conductive material, and may alternatively be implemented by plating a third conductive coating on the external surface of the non-conductor. Preferably, the third conductive coating is plated with a silver coating or a gold coating.

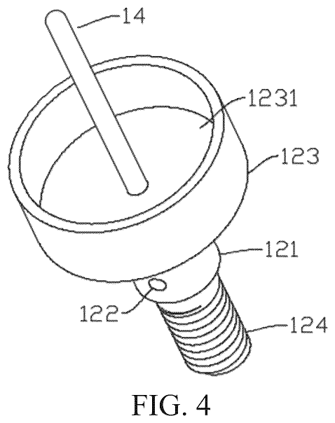

Referring to FIG. 4, the conductor disk 123 is provided with a groove 1231 recessed along the disk surface of the conductor disk 123 facing away from the conductor column 121. The groove 1231 is configured to adjust energy field distribution. During assembling, the lower portion of the accommodating base 13 extends into the groove 1231, and the spacing is provided between the lower portion of the accommodating base 13 and the groove 1231.

In some embodiments, the groove 1231 is in a cylindrical shape, and is coaxial with the conductor disk 123. The diameter of the groove 1231 is greater than the outer diameter of the lower portion of the accommodating base 13, and the depth of the groove 1231 ranges from 1 mm to 5 mm.

It may be understood that, the groove 1231 is provided, and the depth of the groove 1231 is adjusted, so that the energy field distribution can be adjusted, and microwave energy is concentrated to an upper region of the aerosol generation substrate, thereby facilitating rapid aerosol generation when energy is limited. In addition, after the energy field distribution is adjusted, problems such as localized tobacco scorching, low aerosol generation speed, and a small amount of vapor can also be resolved/relieved. Then, because the conductor disk 123 is provided with the groove, the partial structure of the accommodating base 13 can be accommodated in the conductor disk 123, so that the height of the entire microwave heating assembly 100 is correspondingly reduced, thereby reducing the size of the microwave heating assembly 100.

As shown in FIG. 3 and FIG. 4, the probe element 14 includes a longitudinal probe. The lower end of the probe passes through the conductor disk 122, and is coaxially embedded in the conductor column 121 from the top end of the conductor column 121, to be in good ohmic contact with the conductor column 121. The upper end of the probe extends upward into the accommodating base 13. It may be understood that, when extending into the accommodating base 13, the aerosol generation substrate is arranged on the outer periphery of the upper end of the probe. In this case, when the microwaves are fed into the microwave heating assembly 100, a microwave field is formed when the probe element 14 extends into a periphery of the partial structure of the accommodating base 13, to perform microwave heating on the aerosol generation substrate.

The probe element 14 further includes a temperature measurement element arranged in the probe. The temperature measurement element is configured to monitor the internal temperature of an aerosol generation material inserted into the accommodating base 13, to facilitate temperature control. It may be understood that, when the temperature is not need to be measured, the probe is a solid structure; and when the temperature needs to be measured, the probe is a hollow probe.

Optionally, the shape of the end portion of the upper end of the probe includes one of a plane, a sphere, an ellipsoid, a cone, or a frustum of a cone. The shape of a frustum of a cone is preferred because a local field strength can be enhanced in this shape, thereby increasing an atomization speed of an aerosol generation medium.

In some embodiments, the probe is integrally made of a conductive metal material, and preferably, is made of stainless steel, aluminum alloy, or copper. It may be understood that, the probe is not limited to being integrally made of a conductive material, and may alternatively be implemented by plating a fourth conductive coating on the external surface of the non-conductor. Preferably, the fourth conductive coating is plated with a silver coating or a gold coating.

As shown in FIG. 2 and FIG. 3, in some embodiments, the accommodating base 13 includes an accommodating portion 131 and a fixed portion 132 integrally connected to the accommodating portion 131. The accommodating portion 131 is configured to accommodate the aerosol generation substrate. The fixed portion 132 is configured to be axially blocked on the open end 112 of the outer conductor unit 11 and enable the accommodating portion 131 to extend into the cavity.

In some embodiments, the accommodating portion 131 is in a tubular shape (preferably a cylindrical tube), and the outer diameter of the accommodating portion 131 is less than the inner diameter of the outer conductor unit 11. The accommodating portion 131 includes an axial accommodating cavity 1311 configured to accommodate the aerosol generation substrate. The fixed portion 132 is in an annular shape, and is coaxially connected to the accommodating portion 131. The fixed portion 132 is coaxially blocked on the open end 112 of the outer conductor unit 11, so that the accommodating portion 131 is coaxially arranged in the cavity. The fixed portion 132 includes an axial through hole 1321 that communicates the accommodating cavity 1311 with an external environment, and the aerosol generation substrate is inserted into the accommodating cavity 1311 through the through hole 1321.

In some embodiments, the accommodating base 13 further includes several longitudinal positioning ribs 133. These positioning ribs 133 are evenly spaced apart on the periphery of the wall surface of the accommodating cavity 1311 and/or the through hole 1321. Each positioning rib 133 extends along the direction parallel to the axis of the accommodating base 13. The positioning ribs 133 are configured to clamp the aerosol generation substrate inserted into the accommodating cavity 1311 and/or the through hole 1321. In addition, a longitudinally extending air inlet channel is formed between every two adjacent positioning ribs 133, to facilitate ambient air to be inhaled into the bottom portion of the aerosol generation substrate, and then the ambient air enters the aerosol generation substrate, to take away the aerosol generated by the microwaves.

In some embodiments, the accommodating base 13 further includes several longitudinal supporting ribs 134. These supporting ribs 134 are evenly spaced apart, and are radially distributed on the bottom surface of the accommodating cavity 1311. It may be understood that, the supporting rib 134 is configured to support the aerosol generation material. In addition, the supporting rib 134 forms several radiated second air inlet channels. These second air inlet channels are respectively in communication with these first air inlet channels, to facilitate the ambient air to be inhaled into the bottom portion of the aerosol generation material, and then the ambient air enters the aerosol generation material, to take away the aerosol generated by the microwaves.

In some embodiments, the accommodating base 13 is made of a high temperature resistant material with low dielectric loss, and the material can be a polymer material (such as polytetrafluoroethylene (PTFE) and polyether-ether-ketone (PEEK)), or a ceramic material (such as glass, quartz glass, aluminum oxide, and zirconium oxide).

As shown in FIG. 2, in some embodiments, the microwave feeding device 2 is a coaxial connector, is inserted from the feeding hole 115 located on the peripheral side of the outer conductor unit 11, and is mounted on the outer conductor unit 11. The microwave feeding device 2 includes an outer conductor 21, an inner conductor 22 arranged in the outer conductor 21, and a medium layer 23 between the inner conductor 22 and the outer conductor 21.

In some embodiments, the outer conductor 21 is of a straight cylindrical structure with an opening structure at two ends. When the microwave feeding device 2 is mounted on the outer conductor unit 11, the side wall of the outer conductor 21 is in ohmic contact with the inner wall surface of the feeding hole 115 located on the outer conductor unit 11.

The inner conductor 22 is in a straight needle-like structure. One end of the inner conductor 22 is a connection end 221 located in the outer conductor 21, and the other end of the inner conductor 22 is a feeding end 222 located outside the outer conductor 21. The connection end 221 is configured to be connected to the microwave generation device, to access the microwaves. A connection manner is a coaxial connection manner or a microstrip connection manner. The feeding end 222 is relatively adjacent to the inner conductor unit 12 when the microwave feeding device 2 is mounted on the outer conductor unit 11, and is configured to be inserted into the insertion hole 122 located on the conductor column 121, to implement electric coupling or magnetic coupling, thereby guiding the microwaves to the inner conductor unit 12.

In some other embodiments, the inner conductor 22 may alternatively be in an L-shape, and includes a first segment that is perpendicular to the axis of the microwave heating assembly 100 and a second segment that is parallel to the axis of the microwave heating assembly 100. The first segment is partially located in the outer conductor 21, and one end thereof which is configured to connect to the second segment extend out of the outer conductor 21. Preferably, the first segment and the second segment are integrally formed.

In this embodiment, one end of the second segment that is away from the first segment is in direct ohmic contact with the conductor end wall 114 of the outer conductor unit 11, and an insertion hole 122 does not need to be provided on the conductor column 121. Certainly, the position of the insertion hole may alternatively be changed to the conductor end wall 114 of the outer conductor unit 11. In this case, the insertion hole is axially recessed in the conductor end wall 114.

The following specifically describes functions of the groove 1231 through a comparison experiment.

First, a comparison test is performed on the microwave heating assembly provided with the groove 1231 and the microwave heating assembly 100 not provided with the groove 1231. The depth of the groove 1231 is 4 mm, and the diameter of the groove is 9.6 mm.

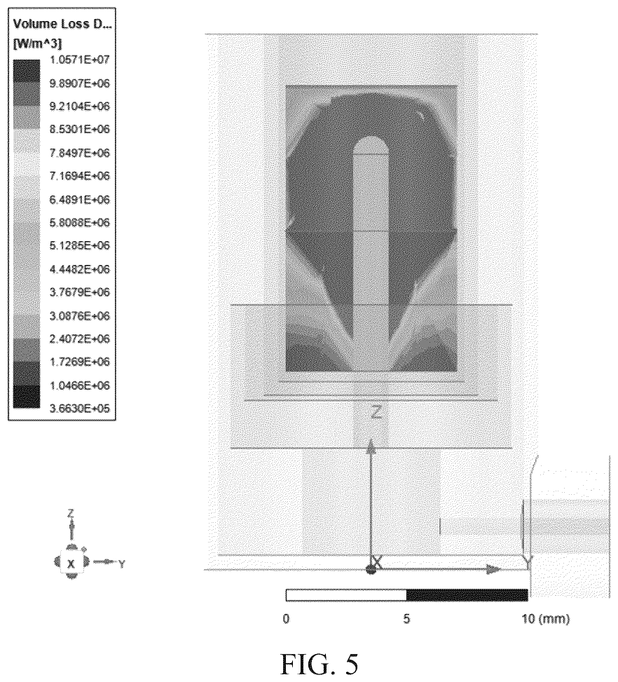

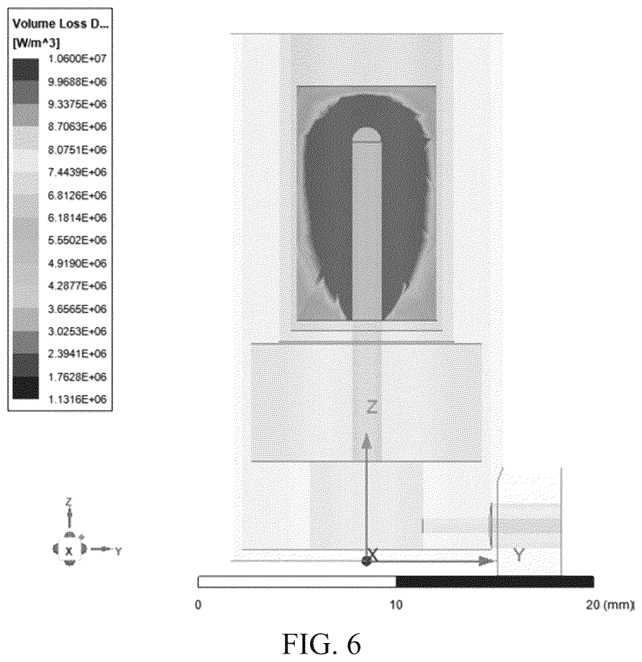

Referring to FIG. 5 and FIG. 6, an energy field distribution diagram of microwave heating assembly provided with the groove 1231 and an energy field distribution diagram of the microwave heating assembly 100 not provided with the groove 1231 are compared. It may be obtained that, in FIG. 6, a dark-colored region surrounding the probe element 14 occupies a significantly reduced area in a bottom region of the aerosol generation substrate, and energy (dark-colored region) concentrates toward an upper region (located above the bottom region) of the aerosol generation substrate. It may be obtained after calculation based on test data that an energy absorption ratio of the upper region of the aerosol generation substrate increases from 61% to 77%.

Then, a comparison test is performed on the microwave heating assemblies 100 provided with the grooves 1231 having different depths. When the depth of the groove 1231 is 2 mm, the energy absorption ratio of the upper region of the aerosol generation substrate is 68%, and compared to the microwave heating assembly 100 provided with the groove having the depth of 4 mm, the energy absorption ratio of the upper region of the aerosol generation substrate is reduced by 9%.

It may be obtained after an experiment that, energy distribution is adjusted mainly by adjusting the depth of the groove 1231, and an impact of the diameter of the groove 1231 on the energy distribution can be ignored. As the depth of the groove 1231 is deeper, the energy is more concentrated toward the upper region of the aerosol generation substrate.

In conclusion, in the present invention, the conductor disk 123 of the inner conductor unit 12 is provided with the groove 1231 to adjust cavity energy field distribution, so that the microwave energy is concentrated on the upper region of the aerosol generation substrate, thereby facilitating rapid aerosol generation when the energy is limited. In addition, after the energy field distribution is adjusted, a problem of a small amount of vapor or a low aerosol generation speed of the aerosol generation substrate may also be resolved.

In addition, because the conductor disk 123 is provided with the groove, the partial structure of the aerosol generation substrate can be accommodated in the conductor disk 123, so that the height of the entire microwave heating assembly 100 is correspondingly reduced, thereby reducing the size of the microwave heating assembly 100.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A microwave heating assembly for an aerosol generation device, comprising:
an outer conductor unit having a tubular shape and comprising an open end and a closed end; and
an inner conductor unit arranged in the outer conductor unit, and comprising:
a first fixed end connected to the closed end; and
a first free end extending toward the open end, a groove recessed toward the closed end being formed on a surface of the first free end toward the open end, the groove being configured to adjust an energy field in the outer conductor unit.

2. The microwave heating assembly of claim 1, wherein the groove has a cylindrical shape.

3. The microwave heating assembly of claim 1, wherein a depth of the groove ranges from 1 mm to 5 mm.

4. The microwave heating assembly of claim 1, wherein the inner conductor unit comprises:
a conductor column comprising a second fixed end and a second free end opposite the second fixed end, the second fixed end being fixed to the closed end; and
a conductor disk combined on the second free end, the groove being formed on a surface of the conductor disk that faces away from the second fixed end.

5. The microwave heating assembly of claim 4, wherein the conductor disk is integrally formed with the conductor column, or the conductor disk is in ohmic contact with the conductor column.

6. The microwave heating assembly of claim 4, wherein the conductor column has a cylindrical shape,
wherein the conductor disk has a disk shape, and
wherein a diameter of the conductor disk is greater than a diameter of the conductor column and less than an inner diameter of the outer conductor unit.

7. The microwave heating assembly of claim 4, wherein the groove, the conductor disk, the conductor column, and the outer conductor unit are coaxial.

8. The microwave heating assembly of claim 4, wherein the conductor disk comprises a metal material, or a surface of the conductor disk is covered with a conductive coating.

9. The microwave heating assembly of claim 8, wherein the metal material comprises aluminum alloy or copper.

10. The microwave heating assembly of claim 8, wherein the conductive coating comprises a silver coating or a gold coating.

11. The microwave heating assembly of claim 4, further comprising:
a probe element arranged in the outer conductor unit, the probe element being in a longitudinal shape,
wherein one end of the probe element passes through the conductor disk, is embedded on the conductor column, and is in ohmic contact with the conductor column, and
wherein an other end of the probe element extends toward the open end.

12. The microwave heating assembly of claim 4, further comprising:
an accommodating base mounted at the open end, the accommodating base comprising an accommodating portion configured to accommodate an aerosol generation substrate, the accommodating portion being arranged in the outer conductor unit,
wherein one end of the accommodating portion that is adjacent to the conductor disk extends into and is arranged in the groove.

13. The microwave heating assembly of claim 12, wherein spacing is provided between an outer wall surface of the accommodating portion and an inner wall surface of the groove.

14. The microwave heating assembly of claim 1, further comprising:
a microwave feeding unit, comprising:
an outer conductor mounted on the outer conductor unit and being in ohmic contact with the outer conductor unit;
an inner conductor arranged in the outer conductor and being in ohmic contact with an inner side of the outer conductor unit or the inner conductor unit; and
a medium layer located between the outer conductor and the inner conductor.

15. The microwave heating assembly of claim 14, wherein an outer periphery side wall of the outer conductor unit is provided with a feeding hole that communicates an interior of the outer conductor unit with an outside,
wherein the outer conductor is embedded in the feeding hole and is in ohmic contact with an inner wall surface of the feeding hole, and
wherein the inner conductor passes through the feeding hole and extends into the outer conductor unit.

16. An aerosol generation device, comprising:
a microwave generation device; and
the microwave heating assembly of claim 1, the microwave heating assembly being connected to the microwave generation device.
